(19) United States
(12) Patent Application Publication
(10) Pub. No.: US 2026/0161760 A1
(43) Pub. Date: Jun. 11, 2026

(54) AUTHENTICATION APPARATUS, AUTHENTICATION SYSTEM, AUTHENTICATION METHOD, AND STORAGE MEDIUM

(71) Applicant: NEC Corporation, Minato-ku, Tokyo (JP)

(72) Inventors: Eisuke KAWAKAMI, Tokyo (JP); Yasunari TSUJI, Tokyo (JP)

(73) Assignee: NEC Corporation, Minato-ku, Tokyo (JP)

(21) Appl. No.: 18/718,532

(22) PCT Filed: Dec. 8, 2022
(86) PCT No.: PCT/JP2022/045349

§ 371 Date: Jun. 11, 2024

(30) Foreign Application Priority Data
Dec. 22, 2021 (JP) 2021-208613

(51) Int. Cl. G06F 21/32; G06V 40/12; G06V 40/14; G06V 40/16; G06V 40/18

(52) U.S. Cl. CPC G06F 21/32; G06V 40/1365; G06V 40/14; G06V 40/172; G06V 40/197

(57) ABSTRACT

An authentication apparatus (101) includes: a first authentication unit (103) that performs first authentication processing by using first biological information and identity verification information; a master information management unit (105) that causes a storage unit (104) to store master information including at least one of first biological information, and feature information indicating a feature of the first biological information, when first authentication processing is successful; and a third authentication unit (106) that performs third authentication processing by using third biological information and the master information, when second authentication processing is successful.

### TECHNICAL FIELD

The present invention relates to an authentication apparatus, an authentication system, an authentication method, and a storage medium.

### BACKGROUND ART

In a terminal such as a smartphone and a tablet, when the terminal is transited from a sleep state to an operating state, when the terminal is activated, and the like, identity authentication processing may be performed in terminal login for logging in to the terminal. The identity authentication processing in terminal login may include, in addition to identity authentication processing by combination of a user identifier (ID) and a password, using biological information such as a face image photographed by a camera, a fingerprint acquired by a sensor, and the like.

Herein, the sleep state is a state in which a utilizable function is restricted by accepting only a restrictive operation, and the like. The operating state is a state in which there is no restriction and the like in the sleep state, and a function of a terminal (including a function of an application or software installed in a terminal) can be utilized. Typically, a terminal in the sleep state accepts an operation for transiting to the operating state, and transits to the operating state when identity authentication processing in terminal login to be performed in response to the acceptance is successful.

Meanwhile, as an application or software (hereinafter, simply referred to as an “app”) to be installed in a terminal, there is an app that performs processing of handling, with high accuracy, highly confidential information such as processing for receiving provision of a service by a bank system. In an app as described above, it is often a case that identity authentication processing in the app is performed, when the app is activated, when provision of a specific service is received by utilizing the app, and the like.

For example, Patent Document 1 discloses a surveillance system including a surveillance apparatus to be operated, and an operator surveillance apparatus that surveys a person operating the surveillance apparatus. The operator surveillance apparatus described in Patent Document 1 includes a face image storage unit in which face image data (collation face image data) acquired by photographing in advance are stored together with an operation authority level.

Further, Patent Document 1 describes that, when the surveillance apparatus is activated by allowing an operator A to whom an operation authority of a high level is given logs in to the surveillance apparatus by using his/her password, face image data of the operator A are imported, and the imported face image data are collated with the collation face image data. Further, there is a description that, by collating face image data (current face image data) of a currently operating operator with the collation face image data when the surveillance apparatus is activated and operated, an operation response to the operation authority is enabled.

### RELATED DOCUMENT

### Patent Document

Patent Document 1: Japanese Patent Application Publication No. 2008-165353

### DISCLOSURE OF THE INVENTION

### Technical Problem

In identity authentication processing in terminal login, there is a case where only a result of the identity authentication processing is output, and biological information itself used in the identity authentication processing is not output. In a case as described above, it is frequently difficult to acquire biological information used in identity authentication processing in terminal login through a function of an app. Even when it is assumed that identity authentication processing in terminal login is utilized for identity authentication processing in an app, it is conceived that, in the identity authentication processing in the app, a result of the identity authentication processing in terminal login is utilized as it is.

However, for example, when image data to be referred to in identity authentication processing in terminal login are tampered with, or the like, there is a possibility that an erroneous result of identity authentication processing may be output in terminal login. Therefore, when the result of identity authentication processing in terminal login is utilized as it is for identity authentication processing in an app, identity authentication processing in the app may be erroneously performed, and accuracy of identity authentication processing in the app may be lowered.

Further, in identity authentication processing in an app, there is a case where identity authentication processing by a method different from terminal login is performed to improve accuracy of identity authentication and the like.

In a case as described above, even when biological information itself to be used in identity authentication processing in terminal login can be acquired by a function of an app, it is difficult to utilize the biological information for identity authentication processing in the app.

The technique described in Patent Document 1 relates to a surveillance system that surveys a person operating a surveillance apparatus, and it is conceived that it is difficult to apply the technique to application login as described above.

The present invention has been made in view of the above-described circumstances, and one of an object of the present invention is to enable to perform identity authentication processing having high accuracy and being different from identity authentication processing in an apparatus such as a terminal.

### Solution to Problem

In order to achieve the above object, an authentication apparatus according to a first aspect of the present invention includes:
a first authentication unit that performs first authentication processing by using first biological information and identity verification information;
a master information management unit that causes a storage unit to store master information including at least one of the first biological information, and feature information indicating a feature of the first biological information, when the first authentication processing is successful; and
a third authentication unit that performs third authentication processing by using third biological information and the master information, when second authentication processing is successful.

In order to achieve the above object, an authentication system according to a second aspect of the present invention includes:
the above-described authentication apparatus; and
the terminal, wherein
the terminal includes
a first generation unit that generates the first biological information,
a second generation unit that generates second biological information,
a third generation unit that generates the third biological information, and
a second authentication unit that performs the second authentication processing by using the second biological information.

In order to achieve the above object, an authentication method according to a third aspect of the present invention includes,
by a computer:
executing first authentication processing by using first biological information and identity verification information;
causing a storage unit to store master information including at least one of the first biological information, and feature information indicating a feature of the first biological information, when the first authentication processing is successful; and
executing third authentication processing by using third biological information and the master information, when second authentication processing is successful.

In order to achieve the above object, a storage medium according to a fourth aspect of the present invention causes a computer to execute:
performing first authentication processing by using first biological information and identity verification information;
causing a storage unit to store master information including at least one of the first biological information, and feature information indicating a feature of the first biological information, when the first authentication processing is successful; and
performing third authentication processing by using third biological information and the master information, when second authentication processing is successful.

### Advantageous Effects of Invention

The present invention enables identity authentication processing having high accuracy and being different from identity authentication processing in an apparatus such as a terminal.

### BRIEF DESCRIPTION OF THE DRAWINGS

FIG. 1 is a diagram illustrating a configuration example of an authentication system according to an example embodiment 1 of the present invention.

FIG. 2 is a diagram illustrating a physical configuration example of an authentication apparatus according to the example embodiment 1.

FIG. 3 is a diagram illustrating a physical configuration example of a terminal according to the example embodiment 1.

FIG. 4 is one example of a flowchart of terminal login according to the example embodiment 1 of the present invention.

FIG. 5 is one example of a flowchart of account opening processing according to the example embodiment 1 of the present invention.

FIG. 6 is one example of a flowchart of account opening processing according to the example embodiment 1 of the present invention.

FIG. 7 is a diagram illustrating one example of structure of master information.

FIG. 8 is one example of a flowchart of system login according to the example embodiment 1 of the present invention.

FIG. 9 is a diagram illustrating a configuration example of an authentication system according to an example embodiment 2 of the present invention.

FIG. 10 is one example of a flowchart of account opening processing according to the example embodiment 2 of the present invention.

FIG. 11 is one example of a flowchart of system login according to the example embodiment 2 of the present invention.

FIG. 12 is a diagram illustrating a configuration example of an authentication apparatus according to a modification example 1.

FIG. 13 is a diagram illustrating a configuration example of an authentication system according to the modification example 1.

FIG. 14 is a flowchart illustrating one example of identity authentication processing according to the modification example 1.

### DESCRIPTION OF EMBODIMENTS

Hereinafter, example embodiments according to the present invention are described by using the drawings. Note that, in all drawings, a similar constituent element is indicated by a similar reference sign, and description thereof is omitted as necessary.

### Example Embodiment 1

An authentication system 100 according to an example embodiment 1 of the present invention is a system that performs identity authentication processing. The identity authentication processing is processing for verifying whether it is the person in question.

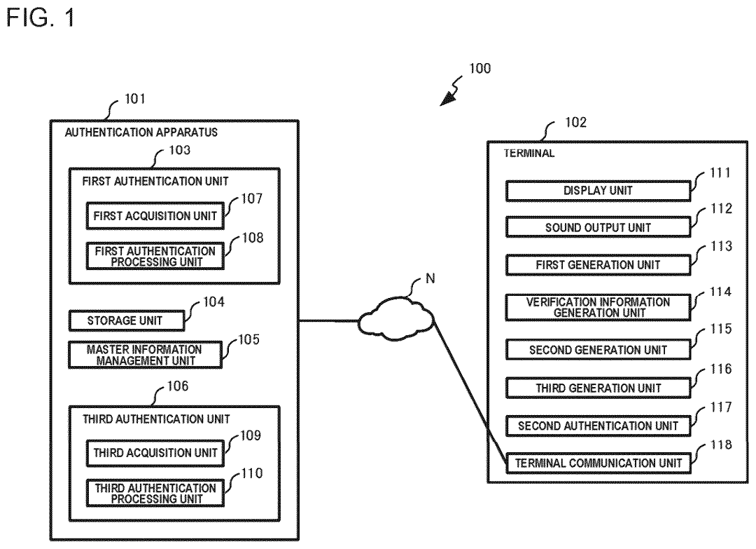

As illustrated in FIG. 1, the authentication system 100 includes an authentication apparatus 101, and a terminal 102 in which an application or software (hereinafter, simply referred to as an “app”) is preinstalled. Note that, the terminal 102 may be plural.

The authentication apparatus 101 and the terminal 102 are connected to each other by a network N being a wired network, a wireless network, or a communication network configured by combining these, and able to mutually transmit and receive information via the network N.

An app to be preinstalled in the terminal 102 is the one for utilizing a service to be provided by a system (computer system) associated with the app. In the present example embodiment, a case where an app to be preinstalled in the terminal 102 is the one for utilizing a service to be provided by a bank system is described as an example. As a service to be provided by a bank system, for example, account opening, money transfer, remittance, and the like are exemplified.

Note that, an app to be installed in the terminal 102 is not limited thereto, but an appropriate one may be available.

### (Functional Configuration of Authentication Apparatus 101)

The authentication apparatus 101 is a bank system server associated with an app. The authentication apparatus 101 performs identity authentication processing for utilizing a service to be provided by a bank system through a function of an app installed in the terminal 102.

As illustrated in FIG. 1, the authentication apparatus 101 functionally includes a first authentication unit 103, a storage unit 104, a master information management unit 105, and a third authentication unit 106. Note that, although not illustrated, the authentication apparatus 101 may further include a function for achieving a service to be provided by a bank system.

The first authentication unit 103 performs first authentication processing by using first biological information and identity verification information.

The first authentication processing is one piece of identity authentication processing to be performed by the authentication apparatus 101. The first authentication processing is, for example, identity authentication processing to be performed when bank account opening or the like is performed through a function of an app installed in the terminal 102. First authentication processing as described above is identity authentication processing to be performed when particularly high accuracy identity verification is required, specifically, particularly high accuracy identity authentication processing.

Specifically, the first authentication unit 103 includes a first acquisition unit 107, and a first authentication processing unit 108.

The first acquisition unit 107 acquires, from the terminal 102, first biological information and identity verification information via the network N.

The first biological information is information related to a living body of the person in question. The first biological information, for example, an image (specifically, a face image) including a face of the person in question, the first biological information includes, in addition to a face image or in place of a face image, an image having at least one of a predetermined facial expression and operation of the person in question.

As will be described later, the first biological information is generated in the terminal 102. Note that, the first biological information may be generated by unillustrated another apparatus connected to the network N.

The first biological information is not limited to these images of the person in question (the image includes a portion other than a face image and a face), and may include, for example, one or a plurality of an image, a fingerprint, a vein, and an iris of the person in question.

The identity verification information is information indicating an identity verification document (a document for identity verification). The document indicated by identity verification information is a document including a face image of the person in question, and, for example, is information indicating a driver's license, a document (so-called an individual number card) indicating an individual number being a number unique to each of the people, and the like. The identity verification information is, for example, image information to be acquired by photographing the document, and is generated by the terminal 102 as will be described later in the present example embodiment.

Note that, the identity verification information may be generated not only by photographing but also by scanning the document with use of a scanner or the like, and may be generated by unillustrated another apparatus connected to the network N.

The first authentication processing unit 108 performs the first authentication processing by using first biological information and identity verification information acquired by the first acquisition unit 107.

Specifically, for example, the first authentication processing unit 108 extracts, in the first authentication processing, a face image included in identity verification information by image processing. Then, in the first authentication processing, determination is made as to whether the extracted face image, and a face image to be acquired from first biological information are a face image of a same person, and a determination result is output. When the face images are the face image of the same person, the determination result indicates that the first authentication processing is successful, and when the face images are not the face image of the same person, the determination result indicates that the first authentication processing has failed.

A conventional technique may be applied to each of image processing for extracting a face image included in identity verification information, and image processing for determining whether the face image is a face image of a same person. As a technique as described above, for example, an image processing technique using machine learning is suitable.

For example, the first authentication processing unit 108 extracts a face image included in identity verification information by using a learning model learned by machine learning. In this case, the first authentication processing unit 108 outputs a face image included in identity verification information by inputting the identity verification information to the learned learning model in which machine learning for extracting a face of a person from image information indicating a document has been performed.

Input data to the learning model at a learning time are image information of a document including a face image of a person. In the input data, image information of a document of a same type as that of a document indicated by identity verification information may be adopted. Then, in machine learning, supervised learning in which an area of a face of a person according to image information is a correct answer may be performed.

For example, the first authentication processing unit 108 determines whether a face image is a face image of a same person by using a learning model learned by machine learning. In this case, the first authentication processing unit 108 outputs a result of determination as to whether a face image extracted from identity verification information, and a face image included in first biological information are of a same person by inputting the face image extracted from the identity verification information, and the first biological information including the face image to a learned learning model in which machine learning for determining whether the face image extracted from the identity verification information, and the face image included in the first biological information are the face image of the same person has been performed.

Input data to the learning model at a learning time are a face image extracted from identity verification information, and first biological information including the face image. In the input data, identity verification information and first biological information of a same person, and identity verification information and first biological information of a different person may be used. Then, in machine learning, supervised learning in which determination as to whether the face image extracted from the identity verification information, and the face image included in the first biological information are the same person is a correct answer may be performed.

For example, when first biological information includes an image having at least one of a predetermined facial expression and operation of the person in question, in the first authentication processing, a face image for the first authentication processing may be determined from an image included in the first biological information. In this case, the first authentication processing unit 108 outputs a face image for the first authentication processing by inputting the first biological information to a learned learning model in which machine learning for determining the face image for the first authentication processing from the first biological information has been performed.

Input data to the learning model at a learning time are first biological information including an image having a predetermined facial expression and operation. Then, in machine learning, supervised learning in which determination as to whether a determination result to be acquired by using, as input data, a face image determined from first biological information, and a face image included in an identity verification document is correct is a correct answer may be performed by using the learning model for determining whether the face images are a face image of a same person.

In the identity verification document, it is often a case where an expressionless face image is adopted, and it is desirable to use a face image of a facial expression close to that of the face image for comparison with the face image included in the identity verification document. Performing processing of determining a face image for the first authentication processing from first biological information enables to acquire a face image appropriate for the first authentication processing from an image of a predetermined facial expression and operation included in the first biological information. In this case, by using the determined face image, and the face image extracted from the identity verification information, determination may be made as to whether these face images are a face image of a same person.

Note that, the first acquisition unit 107 may acquire personal information including one or a plurality of an address, a name, a birthdate, and the like of the person in question. In this case, the first authentication processing unit 108 may further determine whether the personal information to be acquired by the first acquisition unit 107, and personal information included in identity verification information match with each other. As a technique for acquiring personal information from identity verification information, for example, a conventional character recognition technique may be adopted.

The storage unit 104 stores various pieces of information. The storage unit 104 stores, for example, master information. The master information is information including at least one of first biological information, and feature information indicating a feature of the first biological information.

The master information management unit 105 causes the storage unit 104 to store master information.

When master information includes first biological information, the master information management unit 105 causes the storage unit 104 to store the first biological information acquired by the first acquisition unit 107. When master information includes feature information, the master information management unit 105 generates, from the first biological information acquired by the first acquisition unit 107, the feature information related to a predetermined feature, and causes the storage unit 104 to store the generated feature information. The feature information includes, for example, a value related to a predetermined feature.

The third authentication unit 106 performs third authentication processing by using third biological information and master information, when second authentication processing is successful.

Herein, the second authentication processing is identity authentication processing to be performed by the terminal 102, and is different from the first authentication processing and the third authentication processing. The second authentication processing is, for example, identity authentication processing to be performed in terminal login for logging in to the terminal 102.

The third authentication processing is one piece of identity authentication processing to be performed by the authentication apparatus 101. The third authentication unit 106 is, for example, identity authentication processing for logging in to a bank system associated with an app installed in the terminal 102.

Also in the third authentication processing, identity verification information may be used, but identity verification information may not be used. In this regard, accuracy of the third authentication processing may be lower than that of the first authentication processing.

However, master information to be generated based on first biological information acquired in the first authentication processing is used. Further, when the first biological information includes an image having a predetermined facial expression or operation, it is possible to improve accuracy of the third authentication processing also by this factor. Therefore, the third authentication processing is identity authentication processing in which a certain degree of high accuracy is ensured, specifically, high accuracy identity authentication processing.

Further, it can be said that the third authentication processing is generally identity authentication processing having high accuracy as compared with the second authentication processing in a point that biological authentication is used, when the second authentication processing is identity authentication processing by combination of a user identifier (ID) and a password.

Even when the second authentication processing uses biological information, it is frequently unclear how and which piece of biological information is used for the second authentication processing. In contrast, since the third authentication processing is performed by the authentication apparatus 101, it is clear how and which piece of biological information is used to perform identity authentication processing. Therefore, it can be said that the third authentication processing is identity authentication processing in which a certain degree of high accuracy is securely ensured, specifically, high accuracy identity authentication processing.

Specifically, the third authentication unit 106 includes a third acquisition unit 109, and a third authentication processing unit 110.

The third acquisition unit 109 acquires, from the terminal 102, third biological information via the network N. The third biological information is transmitted from the terminal 102, for example, during or after execution of the second authentication processing, and acquired from the terminal during or after execution of the second authentication processing.

The third biological information is information related to a living body of the person in question. The third biological information is generated by the terminal 102 in the present example embodiment. The third biological information includes, for example, a face image of the person in question, or in addition to a face image or in place of a face image, includes an image of a predetermined facial expression or operation of the person in question.

The third biological information may include biological information of a same type as that of biological information included in the first biological information, is not limited to these images (the image includes a portion other than a face image and a face) of the person in question, and may include, for example, one or a plurality of an image, a fingerprint, a vein, and an iris of the person in question.

When the second authentication processing to be performed by the terminal 102 is successful, the third authentication processing unit 110 performs the third authentication processing by using third biological information acquired by the third acquisition unit 109, and master information stored in the storage unit 104.

Specifically, for example, when master information includes first biological information, the third authentication processing unit 110 generates, from the first biological information, feature information related to a predetermined feature. When master information includes feature information, the third authentication processing unit 110 acquires the feature information from the storage unit 104.

The third authentication processing unit 110 generates, from third biological information acquired by the third acquisition unit 109, feature information related to a predetermined feature.

Then, the third authentication processing unit 110 compares the feature information to be acquired from the master information with the feature information to be acquired from the third biological information, and determines, based on a result of the comparison, whether each of the master information and the third biological information is information on a same person. When the information is information on the same person, the determination result indicates that the third authentication processing is successful, and when the information is not information on the same person, the determination result indicates that the third authentication processing has failed.

A conventional technique may be applied to processing for determining whether information is information on a same person. As a technique as described above, for example, an image processing technique using machine learning is suitable.

For example, the third authentication processing unit 110 determines whether master information and third biological information are pieces of information on a same person by using a learning model learned by machine learning. In this case, the third authentication processing unit 110 outputs a determination result as to whether the master information and the third biological information are pieces of information on the same person by inputting the master information and the third biological information to the learned learning model in which machine learning for determining whether these pieces of information are the pieces of information on the same person has been performed.

Input data to the learning model at a learning time are master information including at least one of first biological information and feature information to be acquired from the first biological information, and third biological information. In the input data, master information and third biological information on a same person, and master information and biological information on the same person of a different person may be used. Then, in machine learning, supervised learning in which determination as to whether the master information and the third biological information are pieces of information on the same person is a correct answer may be performed.

### (Functional Configuration of Terminal 102)

The terminal 102 includes a display unit 111, a sound output unit 112, a first generation unit 113, a verification information generation unit 114, a second generation unit 115, a third generation unit 116, a second authentication unit 117, and a terminal communication unit 118.

The display unit 111 displays various pieces of information. The sound output unit 112 outputs a sound.

Upon receiving an instruction to perform account opening or the like through a function of a preinstalled app, the first generation unit 113 generates first biological information. For example, the first generation unit 113 photographs the person in question, and generates first biological information including a photographed image. The image may be any of a still image and a moving image.

For example, when the first biological information includes a face image, at a photographing time, a guide indicating a range within which a face is located is displayed on the display unit 111 together with a photographed real-time image. When the face is located within the predetermined range of a photographing area, the first generation unit 113 photographs the face, and generates first biological information including a face image. Note that, it may be guided in such a way that a face is located within a predetermined range by a sound such as “Locate the face at a middle of a screen” in place of the guide on the display unit 111 or together with the guide.

For example, when the first biological information includes an image having at least one of a predetermined facial expression and operation of the person in question, at a photographing time, at least one of the predetermined facial expression and operation is instructed to the person in question by one or both of a character to be displayed on the display unit 111, and a sound to be output from the sound output unit 112. The first generation unit 113 photographs the person in question having the facial expression, operation, and the like following the instruction, and generates the first biological information including an image having at least one of the predetermined facial expression and operation.

The verification information generation unit 114 generates identity verification information following generation of the first biological information by the first generation unit 113. The verification information generation unit 114 photographs, for example, an identity verification document, and generates identity verification information including a photographed image.

When generating the identity verification information, for example, at a photographing time, a guide indicating a range within which the identity verification document is located is displayed on the display unit 111 together with a photographed real-time image. When the identity verification document is located within the predetermined range of a photographing area, the verification information generation unit 114 photographs the identity verification document, and generates the identity verification information including an image of the identity verification document. Note that, it may be guided in such a way that a face is located within a predetermined range by a sound such as “Locate the identity verification document at a middle of a screen” in place of the guide on the display unit 111 or together with the guide.

Note that, any of generation of first biological information by the first generation unit 113, and generation of identity verification information by the verification information generation unit 114 may be performed first after receiving an instruction to perform account opening or the like.

Upon receiving an instruction to log in to the terminal 102, for example, the second generation unit 115 generates second biological information. The second biological information is biological information to be used in the second authentication processing to be described later. The second biological information includes at least one of a face image, a fingerprint, a vein, and an iris. Specifically, the second biological information may include biological information of a same type as that of biological information included in first biological information, or may include biological information of a different type from that of biological information included in the first biological information.

Upon receiving an instruction to log in to a bank system through a function of a preinstalled app, the third generation unit 116 generates third biological information. The third generation unit 116 photographs, for example, the person in question, and generates third biological information including a photographed image. The image may be any of a still image and a moving image.

For example, when the third biological information includes a face image, the third generation unit 116 generates the third biological information including the face image by a method similar to the method described when first biological information includes the face image.

For example, when the third biological information includes an image having at least one of a predetermined facial expression and operation of the person in question, the third generation unit 116 generates the third biological information including the image having at least one of the predetermined facial expression and operation by a method similar to the method described when first biological information includes an image similar to the one image.

When second biological information is generated by the second generation unit 115, the second authentication unit 117 performs the second authentication processing by using the second biological information. The second authentication processing is, for example, identity authentication processing to be performed in terminal login. The second authentication unit 117 is typically a function to be achieved by software to be installed in the terminal 102 together with an operating system (OS) of the terminal 102.

The terminal communication unit 118 transmits and receives information to and from the authentication apparatus 101 via the network N.

The terminal communication unit 118 transmits, to the authentication apparatus 101, for example, first biological information and identity verification information to be generated in response to receiving an instruction to perform account opening or the like. The terminal communication unit 118 transmits, to the authentication apparatus 101, for example, third biological information to be generated in response to receiving an instruction to log in to a bank system.

So far, a functional configuration of the authentication system 100 according to the example embodiment 1 has been mainly described. From now, a physical operation of the authentication system 100 according to the example embodiment 1 is described.

The authentication system 100 is physically constituted of the authentication apparatus 101, and the terminal 102 connected via the network N to each other.

### (Physical Configuration of Authentication Apparatus 101)

The authentication apparatus 101 is physically, for example, a general-purpose computer or the like.

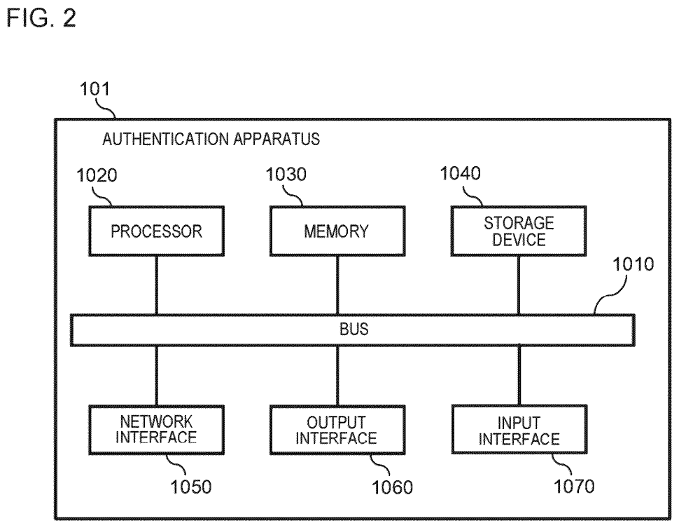

Specifically, as illustrated a physical configuration in FIG. 2, for example, the authentication apparatus 101 includes a bus 1010, a processor 1020, a memory 1030, a storage device 1040, a network interface 1050, an output interface 1060, and an input interface 1070.

The bus 1010 is a data transmission path along which the processor 1020, the memory 1030, the storage device 1040, the network interface 1050, the output interface 1060, and the input interface 1070 mutually transmit and receive data. However, a method of mutually connecting the processor 1020 and the like is not limited to bus connection.

The processor 1020 is a processor to be achieved by a central processing unit (CPU), a graphics processing unit (GPU), or the like.

The memory 1030 is a main storage apparatus to be achieved by a random access memory (RAM) or the like.

The storage device 1040 is an auxiliary storage apparatus to be achieved by a hard disk drive (HDD), a solid state drive (SSD), a memory card, a read only memory (ROM), or the like. The storage device 1040 stores a program module for achieving each functional unit of the authentication apparatus 101. Each functional unit associated with a program module is achieved by causing the processor 1020 to read each program module in the memory 1030 and execute the program module.

The network interface 1050 is an interface for connecting the authentication apparatus 101 to the network N.

The output interface 1060 is a liquid crystal panel, an organic electro-luminescence (EL) panel, and the like as an interface for providing information to a user.

The input interface 1070 is a touch panel, a keyboard, a mouse, and the like as an interface for allowing a user to input information.

### (Physical Configuration of Terminal 102)

The terminal 102 is physically, for example, a tablet personal computer (PC), a smartphone, and the like.

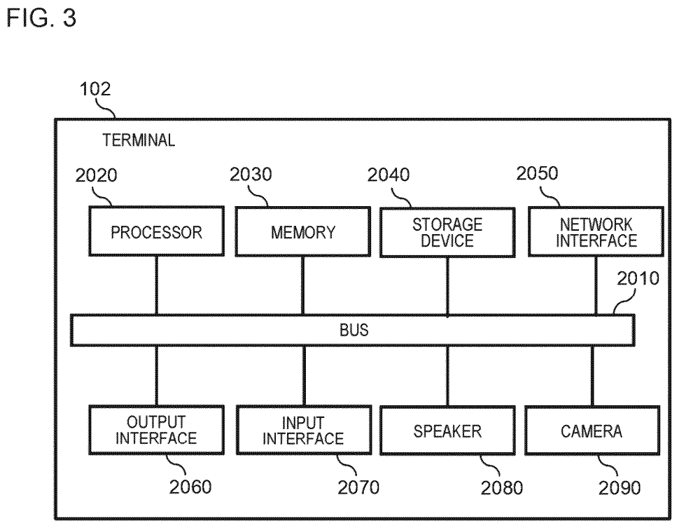

Specifically, as illustrated a physical configuration in FIG. 3, for example, the terminal 102 includes a bus 2010, a processor 2020, a memory 2030, a storage device 2040, a network interface 2050, an output interface 2060, an input interface 2070, a speaker 2080, and a camera 2090.

The bus 2010 is a data transmission path along which the processor 2020, the memory 2030, the storage device 2040, the network interface 2050, the output interface 2060, the input interface 2070, the speaker 2080, and the camera 2090 mutually transmit and receive data. However, a method of mutually connecting the processor 2020 and the like is not limited to bus connection.

The processor 2020 is a processor to be achieved by a CPU, a GPU, or the like. The memory 2030 is a main storage apparatus to be achieved by a RAM or the like. The storage device 2040 is an auxiliary storage apparatus to be achieved by an HDD, an SSD, a memory card, a ROM, or the like.

The storage device 2040 stores a program module for achieving each functional unit of the terminal 102. Each functional unit associated with a program module is achieved by causing the processor 2020 to read each program module in the memory 2030 and execute the program module.

In the present example embodiment, a program module to be stored in the storage device 2040 is included in an operating system (OS) of the terminal 102, an app, or the like. Generally, some of the functions of an app may be achieved only by a program module of the app, but some of the functions of the app may be achieved by combining a function to be achieved by a program module of the app, and a function to be achieved by a program module of an OS.

Functions of the display unit 111, the sound output unit 112, the first generation unit 113, the verification information generation unit 114, the third generation unit 116, and the terminal communication unit 118 according to the present example embodiment include a function to be achieved by a program module included in an app. Functions of the second generation unit 115 and the second authentication unit 117 are functions to be achieved by a program module included in an OS.

The network interface 2050 is an interface for connecting the terminal 102 to the network N. The output interface 2060 is a liquid crystal panel, an organic EL panel, and the like as an interface for providing information to a user. The input interface 2070 is a touch panel, a keyboard, a mouse, and the like as an interface for allowing a user to input information.

The speaker 2080 outputs a sound. The camera 2090 is an apparatus for photographing a target object, and generates image information including the target object.

Note that, the terminal 102 may include, in place of or in addition to the camera 2090, at least one of a sensor for detecting a fingerprint, a sensor for detecting a vein, and a sensor for detecting an iris.

So far, a physical configuration of the authentication system 100 according to the example embodiment 1 has been mainly described. From now, an operation of the authentication system 100 according to the example embodiment 1 is described.

### (Operation of Authentication System 100)

The authentication system 100 performs identity authentication processing. The identity authentication processing includes terminal login, account opening processing, system login, and the like.

### (Terminal Login)

The terminal login is processing for logging in to the terminal 102, and is performed, for example, when the terminal 102 is transited from a sleep state to an operating state, when power of the terminal 102 is turned on, and the like.

The sleep state is a state in which a utilizable function is restricted. In the sleep state, for example, a utilizable function is restricted by limiting an operation for acceptance to a predetermined operation such as an operation for transiting to the operating state.

The operating state is a state in which a function of a terminal (including a function of an application or software installed in a terminal) can be utilized. When identity authentication processing (second authentication processing) in terminal login is successful, the terminal 102 is brought to the operating state.

In the present example embodiment, not only when power is turned off, but also when the terminal 102 is in the sleep state, utilization of a function of an app in the terminal 102 is restricted. Therefore, terminal login becomes a premise for utilizing a bank system through the terminal 102. The terminal login is started, for example, when a predetermined operation (e.g., contact with a touch panel, or pressing of a button) for logging in to the terminal 102 is performed, or when power of the terminal 102 is turned on.

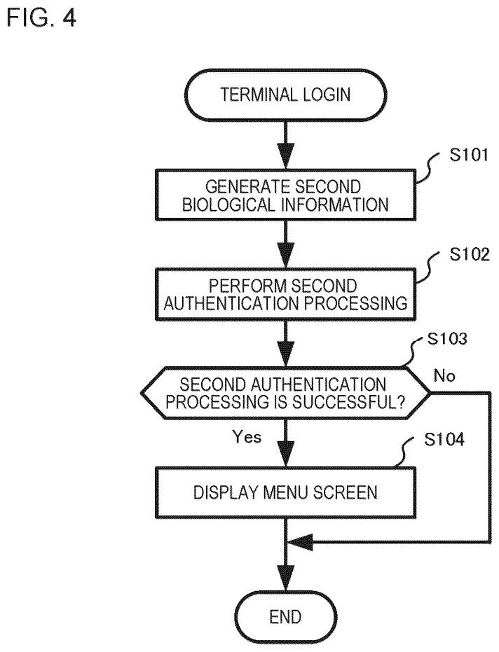

As illustrated in a flowchart in FIG. 4, the second generation unit 115 generates second biological information (step S101).

Specifically, for example, when an operation for logging in to the terminal 102, or power is turned on, the second generation unit 115 starts detection by a sensor in response to the operation. Herein, a case where a sensor is a camera is described as an example. In this case, the second generation unit 115 starts photographing in response to the operation. Then, the second generation unit 115 generates second biological information including a photographed image.

The second authentication unit 117 performs the second authentication processing by using the second biological information generated in step S101 (step S102).

Specifically, for example, the second authentication unit 117 compares a feature value of a pre-registered face image with a feature value of an image included in the second biological information, and determines whether these feature values match with each other. The face image to be pre-registered is a face image of a user of the terminal 102, and information including the face image is held in advance, for example, in the second authentication unit 117.

Herein, matching is not limited to a case where feature values are the same, but also include a case where a difference between feature values lies within a predetermined range, and the same is true for the following.

The second authentication unit 117 determines whether the second authentication processing is successful (step S103).

Specifically, for example, when a face image is included in the second biological information, and a feature value of the face image and a feature value of a pre-registered face image match with each other, the second authentication unit 117 determines that the second authentication processing is successful. Further, when a face image is not included in the second biological information, and when feature values of the face image included in the second biological information, and the pre-registered face image do not match with each other, the second authentication unit 117 determines that the second authentication processing has failed.

When it is determined that the second authentication processing has failed (step S103: No), the second authentication unit 117 finishes the terminal login. In this case, the terminal 102 maintains the sleep state, or after power is turned on, the terminal 102 is brought to the sleep state. At this occasion, the second authentication unit 117 may cause the display unit 111 to display a message that the second authentication processing has failed.

When it is determined that the second authentication processing is successful (step S103: Yes), the second authentication unit 117 sets the terminal 102 to the operating state, causes the display unit 111 to display, for example, a menu screen being an initial screen (step S104), and finishes the terminal login.

### (Account Opening Processing)

The account opening processing is processing for opening a bank account through the terminal 102. The account opening processing is started, for example, when an app is activated after terminal login to the terminal 102, and in response to receiving an instruction to start the account opening processing.

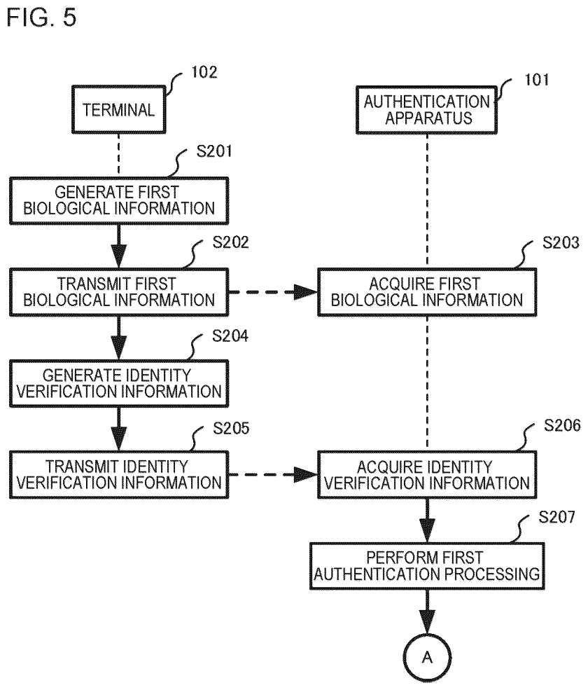

As illustrated in a flowchart in FIG. 5, the first generation unit 113 generates first biological information (step S201).

Specifically, for example, when an operation for starting the account opening processing is performed, the first generation unit 113 starts photographing in response to the operation. The first generation unit 113 causes the display unit 111 to display a guide indicating a range within which a face is located together with a photographed real-time image. When the face is located within a predetermined range of a photographing area, the first generation unit 113 generates first biological information including a face image at that time.

The terminal communication unit 118 transmits, to the authentication apparatus 101, the first biological information generated in step S201 via the network N (step S202). Thus, the first acquisition unit 107 acquires the first biological information from the terminal 102 (step S203).

The verification information generation unit 114 generates identity verification information (step S204).

Specifically, for example, the verification information generation unit 114 causes the display unit 111 to display a guide indicating a range within which an identity verification document is located together with a real-time image photographed by a camera. When the identity verification document is located within a predetermined range of a photographing area, the verification information generation unit 114 generates identity verification information including an image of the identity verification document at that time.

The terminal communication unit 118 transmits, to the authentication apparatus 101, the identity verification information generated in step S204 via the network N (step S205). Thus, the first acquisition unit 107 acquires the identity verification information from the terminal 102 (step S206).

The first authentication acquisition unit 108 performs the first authentication processing by using the first biological information and the identity verification information acquired in steps S203 and S106 (step S207).

Specifically, for example, the first authentication processing unit 108 extracts a face image included in the identity verification information by image processing, and derives a feature value of the extracted face image. The first authentication processing unit 108 derives a feature value of a face image included in the first biological information.

The first authentication processing unit 108 compares the feature value of the face image included in the identity verification information with the feature value of the face image included in the first biological information. When these compared feature values match with each other, the first authentication processing unit 108 determines that the face images included in the identity verification information and the first biological information are of a same person. When the compared feature values do not match with each other, the first authentication processing unit 108 determines that the face images included in the identity verification information and the first biological information are not of a same person.

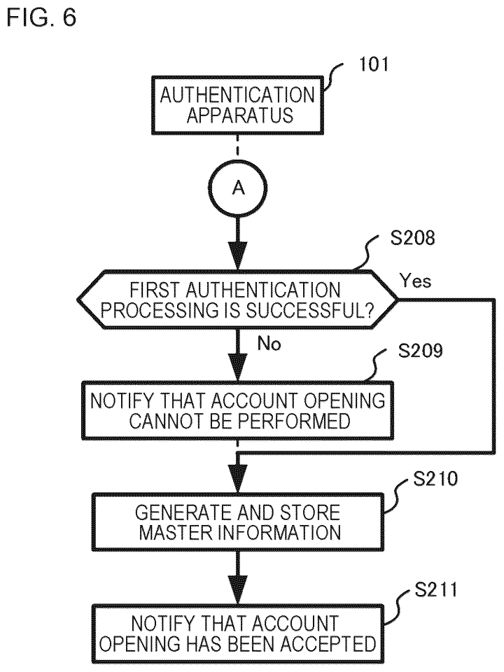

As illustrated in FIG. 6, the first authentication unit 103 determines whether the first authentication processing is successful (step S208).

Specifically, for example, when the face images included in the identity verification information and the first biological information are of a same person, the first authentication unit 103 determines that the first authentication processing is successful. Further, when the face images included in the identity verification information and the first biological information are not of a same person, the first authentication unit 103 determines that the first authentication processing has failed.

When it is determined that the first authentication processing has failed (step S208: No), the first authentication unit 103 performs notification that account opening cannot be performed to the terminal 102 via the network N (step S209), and ends the account opening processing.

The notification transmitted in step S209 is acquired by the terminal communication unit 118, and the terminal communication unit 118 causes the display unit 111 to display, for example, a message indicating that account opening cannot be performed. Thus, a user can know that the first authentication processing has failed.

Further, the notification in step S209 may also include a user ID of master information, and the user ID may be acquired and held, for example, by the third acquisition unit 109.

When it is determined that the first authentication processing is successful (step S208: Yes), the master information management unit 105 generates master information, and causes the storage unit 104 to store the generated master information (step S210).

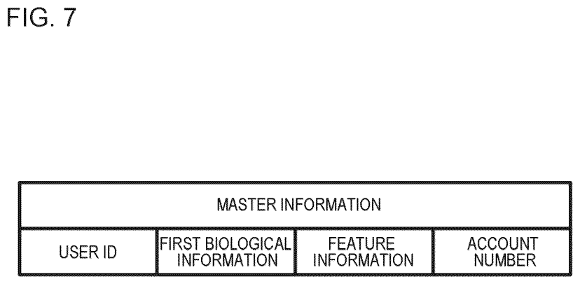

FIG. 7 is a diagram illustrating one example of master information to be generated and stored in step S210. In the master information illustrated in FIG. 7, a user ID, first biological information, feature information, and an account number are associated with one another.

The user ID is information for identifying a user. The first biological information is information acquired in step S203. The feature information includes a feature value of a face image included in the first biological information. The feature value of the face image included in the first biological information is acquired in step S207. The account number is a number for identifying an account, and is given, for example, when master information is generated in accordance with a predetermined rule.

Note that, when personal information is acquired from the terminal 102 by the first acquisition unit 107, the personal information may be further included in master information.

The first authentication unit 103 performs notification that account opening has been accepted to the terminal 102 via the network N (step S211), and ends the account opening processing.

The notification transmitted in step S211 is acquired by the terminal communication unit 118, and the terminal communication unit 118 causes the display unit 111 to display, for example, a message indicating that account opening has been accepted. Thus, a user can know that the first authentication processing is successful.

### (System Login)

The system login is processing for logging in to a bank system through the terminal 102. The system is a system associated with an app installed in the terminal 102. Logging in to the system allows a user to utilize, for example, a service such as money transfer and remittance utilizing an opened account after opening in which the account is utilized.

The system login is, for example, started when an operation of activating an app is performed after terminal login to the terminal 102.

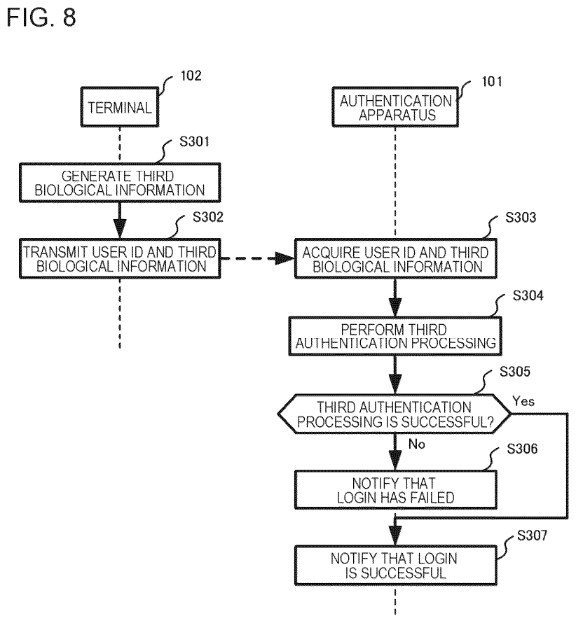

As illustrated in a flowchart in FIG. 8, the third generation unit 116 generates third biological information (step S301).

Specifically, for example, when an operation for activating an app is performed, the third generation unit 116 starts photographing in response to the operation. The third generation unit 116 causes the display unit 111 to display a guide indicating a range within which a face is located together with a photographed real-time image. When the face is located within a predetermined range of a photographing area, the third generation unit 116 generates third biological information including a face image at that time.

Note that, the processing in step S301 may be performed at a midway when step S101 is performed in terminal login. In this case, in step S101, second biological information and third biological information are generated by using a common face image generated by a camera.

The terminal communication unit 118 transmits, to the authentication apparatus 101, a user ID held in advance, and the third biological information generated in step $301 via the network N (step S302). Thus, the third acquisition unit 109 acquires the user ID and the third biological information from the terminal 102 (step S303).

The third authentication unit 110 performs the third authentication processing by using the user ID and the third biological information acquired in step S303, and the master information stored in the storage unit 104 in step S210 (step S304).

Specifically, for example, the third authentication processing unit 110 acquires feature information associated with the user ID acquired in step S303 by referring to the master information. Note that, the third authentication processing unit 110 may acquire feature information by deriving a feature value of a face image included in first biological information by using the first biological information included in the master information.

The third authentication processing unit 110 derives a feature value of a face image included in the third biological information.

The third authentication processing unit 110 compares a feature value included in feature information of the master information with a feature value of a face image included in the third biological information. When these compared feature values match with each other, the third authentication processing unit 110 determines that the feature information of the master information, and the third biological information are information on a same person. When the compared feature values do not match with each other, the third authentication processing unit 110 determines that the feature information of the master information, and the third biological information are not information on a same person.

The third authentication unit 106 determines whether the third authentication processing is successful (step S305).

Specifically, for example, when the feature information of the master information, and the third biological information are information on a same person, the third authentication unit 106 determines that the third authentication processing is successful. Further, when the feature information of the master information, and the third biological information are not information on a same person, the third authentication unit 106 determines that the third authentication processing has failed.

When it is determined that the third authentication processing has failed (step S305: No), the third authentication unit 106 performs notification that login has failed to the terminal 102 via the network N (step S306), and ends the account opening processing.

The notification transmitted in step S306 is acquired by the terminal communication unit 118, and the terminal communication unit 118 causes the display unit 111 to display, for example, a message that login has failed. Thus, a user can know that the third authentication processing has failed.

When it is determined that the third authentication processing is successful (step S305: Yes), the third authentication unit 106 performs notification that login is successful to the terminal 102 via the network N (step S307), and ends the account opening processing.

The notification transmitted in step S306 is acquired by the terminal communication unit 118, and the terminal communication unit 118 causes the display unit 111 to display, for example, an initial screen such as a menu screen. Thus, a user can know that the third authentication processing is successful, and also utilize a service to be provided by a bank system through the terminal 102.

So far, the example embodiment 1 according to the present invention has been described.

In the present example embodiment, master information including at least one of first biological information to be used in the first authentication processing, and feature information indicating a feature of the first biological information is stored, and when the second authentication processing is successful, the third authentication processing is performed by using third biological information and the master information.

Since the first authentication processing is performed by using first biological information and identity verification information, it is highly likely that the first biological information is information verified by also referring to the identity verification information, and is biological information of the person in question. Therefore, it is highly likely that the first biological information and feature information in the master information are also information based on biological information of the person in question. Since the third authentication processing can be performed by using master information as described above, high accuracy identity verification can be performed in the third authentication processing. Further, the third authentication processing is performed when the second authentication processing is successful.

Therefore, identity authentication processing (first authentication processing and third authentication processing) having high accuracy and being different from identity authentication processing (second authentication processing) in the terminal 102 is enabled.

In the present example embodiment, each piece of processing in the first authentication processing and the third authentication processing is different from processing in the second authentication processing. Specifically, processing in the first authentication processing and processing in the second authentication processing may be different from each other, and processing in the third authentication processing and processing in the second authentication processing may be different from each other. Thus, even when processing in the second authentication processing is unclear, or when the processing is identity authentication having relatively low accuracy, identity authentication having high accuracy can be performed in the first authentication processing and the third authentication processing.

Therefore, identity authentication processing (first authentication processing and third authentication processing) having high accuracy and being different from identity authentication processing (second authentication processing) in the terminal 102 is enabled.

Note that, processing in the first authentication processing and processing in the third authentication processing may be the same, or may be different from each other.

When processing in the first authentication processing and processing in the third authentication processing are the same, since processing can be shared, generation of an app is facilitated, and a data amount of the app can be made small. When processing in the first authentication processing and processing in the third authentication processing are different from each other, identity authentication having accuracy according to a condition required in each of the first authentication processing and the third authentication processing can be performed.

### Example Embodiment 2

The example embodiment 1 has been described by an example in which the authentication apparatus 101 is a bank system server associated with an app. The authentication apparatus 101 may be a terminal in which an app is installed.

### (Functional Configuration of Authentication System 200)

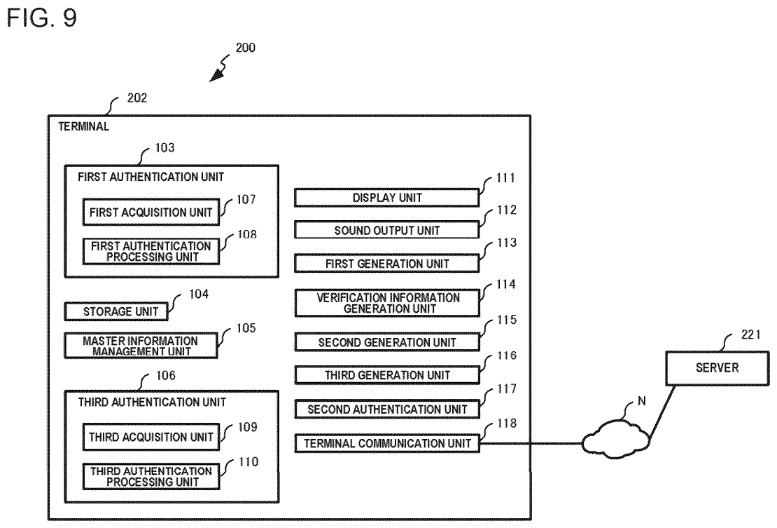

As illustrated in FIG. 9, an authentication system 200 according to the example embodiment 1 of the present invention includes a terminal 202 as an authentication apparatus, and a server 221.

The terminal 202 includes functional units 103 to 106 included in the authentication apparatus 101 according to the example embodiment 1, in addition to functional units 111 to 118 included in the terminal 102 according to the example embodiment 1. However, a first acquisition unit 107 and a third acquisition unit 109 may acquire information via a bus 2010 (see FIG. 3), in place of acquiring information via a network N.

The server 221 is a bank system server associated with an app, and is configured to be able to mutually transmit and receive information to and from the terminal 202 via the network N. The server 221 acquires notification from the terminal 202, and performs processing according to the notification.

### (Physical Configuration of Authentication System 200)

Physically, the terminal 202 may be configured similarly to the terminal 102 according to the example embodiment 1. The server 221 may be configured similarly to the authentication apparatus 101 according to the example embodiment 1.

### (Operation of Authentication System 200)

Terminal login according to the present example embodiment may be similar to terminal login according to the example embodiment 1.

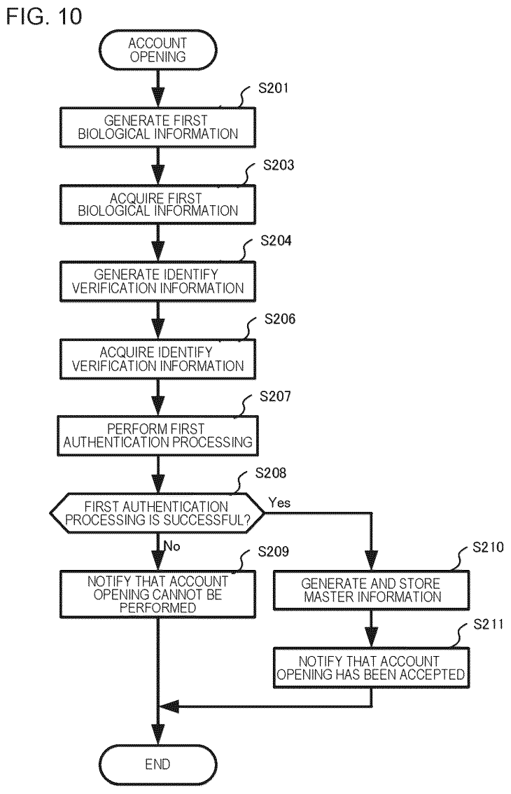

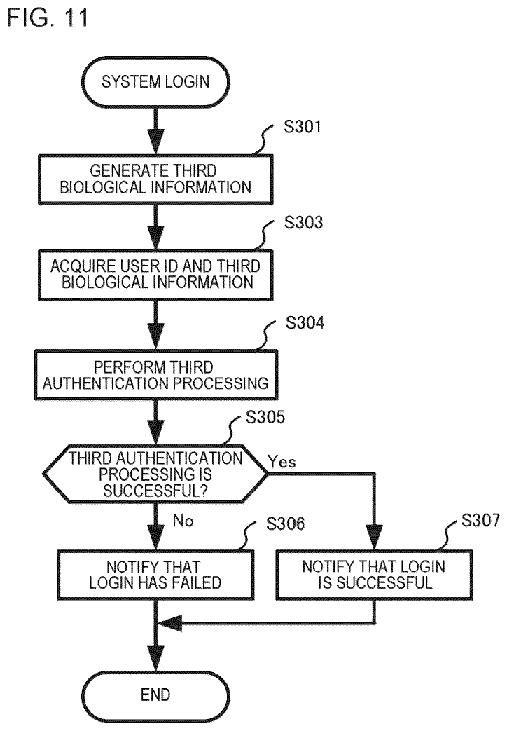

FIGS. 10 and 11 illustrate a flowchart of each of account opening processing and system login according to the present example embodiment.

As illustrated in FIG. 10, in the account opening processing according to the present example embodiment, pieces of processing of steps S201, S203 to S204, and S206 to S211 similar to those of the example embodiment 1 are performed. However, notification in each of steps S209 and S211 is performed by a terminal notification unit 118, and transmitted to the server 221 via the network N.

Receiving the notification in step S209 allows a user of the server 221 to know that account opening has been tried, account opening cannot be performed because first authentication processing has failed, and the like.

Receiving the notification in step S211 allows a user of the server 221 to know that the first authentication processing is successful, and account opening has been accepted. Note that, the notification in step S211 may include at least one of personal information of a person (specifically, a user of the terminal 102) who performed account opening, master information, and the like.

As illustrated in FIG. 11, in the system login according to the present example embodiment, pieces of processing of steps S301, and S303 to S307 similar to those of the example embodiment 1 are performed. However, notification in each of steps S306 and S307 is performed by the terminal notification unit 118, and transmitted to the server 221 via the network N.

Receiving the notification in step S306 allows a user of the server 221 to know that third authentication processing has failed. Receiving the notification in step S307 allows a user of the server 221 to know that the third authentication processing is successful.

Note that, a third authentication unit 106 may cause a display unit 111 to display a message that login has failed, subsequent to or in place of step S306. Thus, a user can know that the third authentication processing has failed. Further, the third authentication unit 106 may cause the display unit 111 to display, for example, an initial screen such as a menu screen, subsequent to or in place of step S307. Thus, a user can know that the third authentication processing is successful.

The present example embodiment also achieves an advantageous effect similar to that of the example embodiment 1.

### Modification Example 1

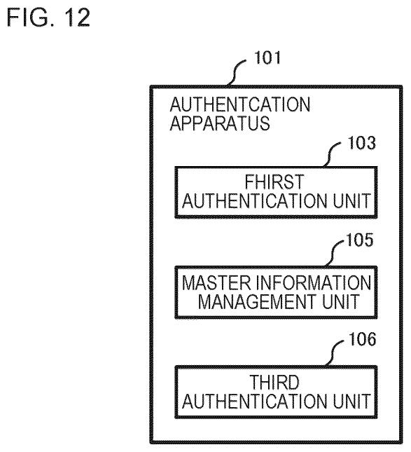

FIG. 12 is a diagram illustrating a configuration example of an authentication apparatus 101 according to a modification example 1. The authentication apparatus 101 includes a first authentication unit 103, a master information management unit 105, and a third authentication unit 106.

The first authentication unit 103 performs first authentication processing by using first biological information and identity verification information. When the first authentication processing is successful, the master information management unit 105 causes a storage unit 104 to store master information including at least one of first biological information, and feature information indicating a feature of the first biological information. When second authentication processing is successful, the third authentication unit 106 performs third authentication processing by using third biological information and the master information.

In the authentication apparatus 101 according to the present modification example 1, even when processing in the second authentication processing is unclear, or when the processing is identity authentication having relatively low accuracy, identity authentication having high accuracy can be performed in the first authentication processing and the third authentication processing. Identity authentication processing (first authentication processing and third authentication processing) having high accuracy and being different from identity authentication processing (second authentication processing) in an apparatus such as a terminal 102 is enabled.

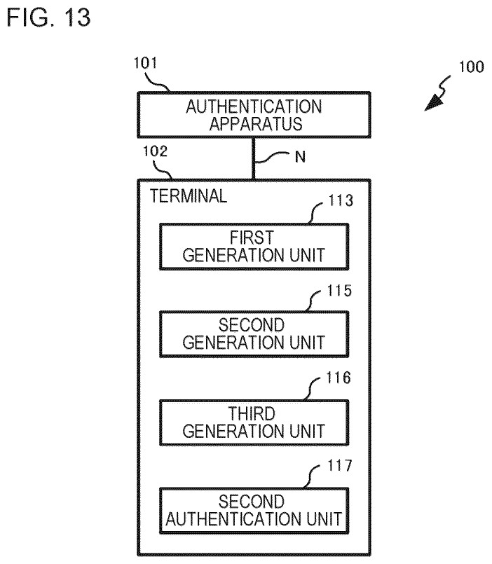

In FIG. 13, an authentication system 100 according to the modification example 1 includes the authentication apparatus 101, and the terminal 102. The terminal 102 includes a first generation unit 113, a second generation unit 115, a third generation unit 116, and a second authentication unit 117.

The first generation unit 113 generates first biological information. The second generation unit 115 generates second biological information. The third generation unit 116 generates third biological information. The second authentication unit 117 performs the second authentication processing by using the second biological information.

In the authentication system 100 according to the present modification example 1, even when processing in the second authentication processing is unclear, or when the processing is identity authentication having relatively low accuracy, identity authentication having high accuracy can be performed in the first authentication processing and the third authentication processing. Identity authentication processing (first authentication processing and third authentication processing) having high accuracy and being different from identity authentication processing (second authentication processing) in an apparatus such as the terminal 102 is enabled.

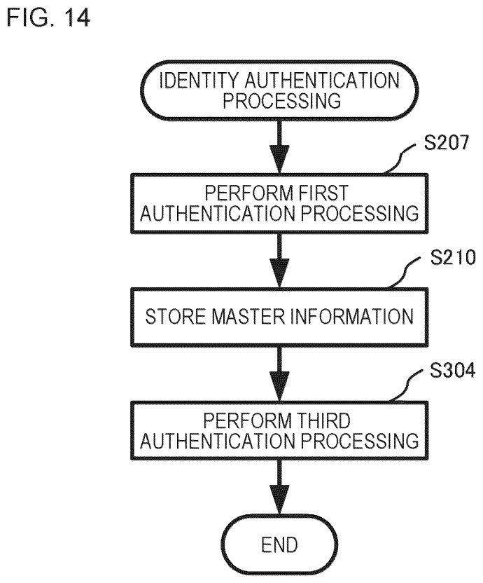

FIG. 14 is a flowchart illustrating one example of identity authentication processing (authentication processing) according to the modification example 1.

The first authentication unit 103 performs the first authentication processing by using first biological information and identity verification information (step S207).

When the first authentication processing is successful, the master information management unit 105 causes the storage unit 104 to store master information including at least one of first biological information, and feature information indicating a feature of the first biological information (step S210).

When the second authentication processing is successful, the third authentication processing unit 110 performs the third authentication processing by using third biological information and the master information (step S304).

In the identity authentication processing (authentication processing) according to the present modification example 1, even when processing in the second authentication processing is unclear, or when the processing is identity authentication having relatively low accuracy, identity authentication having high accuracy can be performed in the first authentication processing and the third authentication processing. Identity authentication (first authentication processing and third authentication processing) having high accuracy and being different from identity authentication processing (second authentication processing) in an apparatus such as the terminal 102 is enabled.

In the foregoing, example embodiments and a modification example according to the present invention have been described with reference to the drawings, however, these are examples of the present invention, and various configurations other than the above can also be adopted.

Further, in a plurality of flowcharts used in the above description, a plurality of processes (pieces of processing) are described in order, however, an order of execution of processes to be performed in each example embodiment is not limited to the order of description. In each example embodiment, the illustrated order of processes can be changed within a range that does not adversely affect a content. Further, the above-described example embodiments and modification example can be combined, as far as contents do not conflict with each other.

A part or all of the above-described example embodiments may also be described as the following supplementary notes, but is not limited to the following.

1.

An authentication apparatus including:
a first authentication unit that performs first authentication processing by using first biological information and identity verification information;
a master information management unit that causes a storage unit to store master information including at least one of the first biological information, and feature information indicating a feature of the first biological information, when the first authentication processing is successful; and
a third authentication unit that performs third authentication processing by using third biological information and the master information, when second authentication processing is successful.
   2.

The authentication apparatus according to supplementary note 1, wherein the first authentication unit includes
a first acquisition unit that acquires, from a terminal, the first biological information and the identity verification information, and
a first authentication processing unit that performs the first authentication processing by using the first biological information and the identity verification information,
the second authentication processing is authentication processing to be performed in the terminal, and
the third authentication unit includes
a third acquisition unit that acquires third biological information from the terminal during or after execution of the second authentication processing, and
a third authentication processing unit that performs the third authentication processing by using third biological information acquired by the third acquisition unit, and the master information, when the second authentication processing is successful.
   3.

The authentication apparatus according to claim 1, further including:
a verification information generation unit that generates the identity verification information;
a first generation unit that generates the first biological information;
a second generation unit that generates second biological information;
a third generation unit that generates the third biological information; and
a second authentication unit that performs the second authentication processing by using the second biological information, wherein
the first authentication unit includes
a first acquisition unit that acquires the first biological information from the first generation unit, and acquires the identity verification information from the verification information generation unit, and
a first authentication processing unit that performs the first authentication processing by using the first biological information and the identity verification information, and
the third authentication unit includes
a third acquisition unit that acquires third biological information to be generated in the terminal during or after execution of second authentication processing by the second authentication unit, and
a third authentication processing unit that performs the third authentication processing by using third biological information acquired by the third acquisition unit, and the master information, when second authentication processing by the second authentication unit is successful.
   4.

The authentication apparatus according to any one of supplementary notes 1 to 3, wherein
the third biological information includes biological information of a same type as that of biological information included in the first biological information.
   5.

The authentication apparatus according to supplementary note 4, wherein
the first biological information and the third biological information include a face image, and
the second biological information includes at least one of a face image, a fingerprint, a vein, and an iris.
   6.

The authentication apparatus according to any one of supplementary notes 1 to 5, wherein
each piece of processing in the first authentication processing and the third authentication processing, and processing in the second authentication processing are different from each other.
   7.

An authentication system including:
the authentication apparatus according to supplementary note 1 or 2; and
the terminal, wherein
the terminal includes
a first generation unit that generates the first biological information,
a second generation unit that generates second biological information,
a third generation unit that generates the third biological information, and
a second authentication unit that performs the second authentication processing by using the second biological information.
   8.

An authentication method including,
by a computer:
executing first authentication processing by using first biological information and identity verification information;
causing a storage unit to store master information including at least one of the first biological information, and feature information indicating a feature of the first biological information, when the first authentication processing is successful; and
executing third authentication processing by using third biological information and the master information, when second authentication processing is successful/
   9.

A program for causing a computer to execute:
performing first authentication processing by using first biological information and identity verification information;
causing a storage unit to store master information including at least one of the first biological information, and feature information indicating a feature of the first biological information, when the first authentication processing is successful; and
performing third authentication processing by using third biological information and the master information, when second authentication processing is successful.
   10.

A storage medium storing a program for causing a computer to execute:
performing first authentication processing by using first biological information and identity verification information;
causing a storage unit to store master information including at least one of the first biological information, and feature information indicating a feature of the first biological information, when the first authentication processing is successful; and
performing third authentication processing by using third biological information and the master information, when second authentication processing is successful.

This application is based upon and claims the benefit of priority from Japanese patent application No. 2021-208613, filed on Dec. 22, 2021, the disclosure of which is incorporated herein in its entirety by reference.

### REFERENCE SIGNS LIST

100, 200 Authentication system
101 Authentication apparatus
102, 202 Terminal
103 First authentication unit
104 Storage unit
105 Master Information Storage Unit
106 Third authentication unit
107 First acquisition unit
108 First authentication processing unit
109 Third acquisition unit
110 Third authentication processing unit
111 Display unit
112 Sound output unit
113 First generation unit
114 Verification information generation unit
115 Second generation unit
116 Third generation unit
117 Second authentication unit
118 Terminal communication unit
221 Server

What is claimed is:

1. An authentication apparatus comprising:
at least one memory configured to store instructions; and
at least one processor configured to execute the instructions to:
perform first authentication processing by using first biological information and identity verification information;
cause the at least one memory to store master information including at least one of the first biological information, and feature information indicating a feature of the first biological information, when the first authentication processing is successful; and
perform third authentication processing by using third biological information and the master information, when second authentication processing is successful.

2. The authentication apparatus according to claim 1, wherein
the first authentication processing includes
acquiring, from a terminal, the first biological information and the identity verification information, and
performing the first authentication processing by using the first biological information and the identity verification information,
the second authentication processing is authentication processing to be performed in the terminal, and
the third authentication processing includes
acquiring third biological information from the terminal during or after execution of the second authentication processing, and
performing the third authentication processing by using third biological information, and the master information, when the second authentication processing is successful.

3. The authentication apparatus according to claim 1, the at least one processor configured to execute further instructions to:
generate the identity verification information;
generate the first biological information;
generate second biological information;
generate the third biological information; and
perform the second authentication processing by using the second biological information, wherein
the first authentication processing includes
acquiring the first biological information, from
acquiring the identity verification information from the verification information generation unit, and
performing the first authentication processing by using the first biological information and the identity verification information, and
the third authentication processing includes
acquiring third biological information to be generated in the terminal during or after execution of second authentication processing, and
performing the third authentication processing by using the third biological information and the master information, when second authentication processing is successful.

4. The authentication apparatus according to claim 1. wherein
the third biological information includes biological information of a same type as that of biological information included in the first biological information.

5. The authentication apparatus according to claim 4, wherein
the first biological information and the third biological information include a face image, and
the second biological information includes at least one of a face image, a fingerprint, a vein, and an iris.

6. The authentication apparatus according to claim 1, wherein
each piece of processing in the first authentication processing and the third authentication processing, and processing in the second authentication processing are different from each other.

7. An authentication system comprising:
the authentication apparatus according to claim 1; and
the terminal, wherein
the terminal includes
at least one memory configured to store instructions; and
at least one processor configured to execute the instructions to:
generate the first biological information,
generates generate second biological information,
generate the third biological information, and
generate the second authentication processing by using the second biological information.

8. An authentication method comprising,
by a computer:
executing first authentication processing by using first biological information and identity verification information;
causing a storage unit to store master information including at least one of the first biological information, and feature information indicating a feature of the first biological information, when the first authentication processing is successful; and
executing third authentication processing by using third biological information and the master information, when second authentication processing is successful.

9. A non-transitory storage medium storing a program for causing a computer to execute:
performing first authentication processing by using first biological information and identity verification information;
causing a storage unit to store master information including at least one of the first biological information, and feature information indicating a feature of the first biological information, when the first authentication processing is successful; and
performing third authentication processing by using third biological information and the master information, when second authentication processing is successful.

10. The authentication system according to claim 7, wherein
the first authentication processing includes
acquiring, from a terminal, the first biological information and the identity verification information, and
performing the first authentication processing by using the first biological information and the identity verification information,
the second authentication processing is authentication processing to be performed in the terminal, and
the third authentication processing includes
acquiring third biological information from the terminal during or after execution of the second authentication processing, and
performing the third authentication processing by using third biological information, and the master information, when the second authentication processing is successful.

11. The authentication method according to claim 8, wherein
the first authentication processing includes
acquiring, from a terminal, the first biological information and the identity verification information, and
performing the first authentication processing by using the first biological information and the identity verification information,
the second authentication processing is authentication processing to be performed in the terminal, and
the third authentication processing includes
acquiring third biological information from the terminal during or after execution of the second authentication processing, and
performing the third authentication processing by using third biological information, and the master information, when the second authentication processing is successful.

12. The authentication method according to claim 8, further comprising:
generating the identity verification information;
generating the first biological information;
generating second biological information;
generating the third biological information; and
performing the second authentication processing by using the second biological information, wherein
the first authentication processing includes
acquiring the first biological information,
acquiring the identity verification information from the verification information generation unit, and
performing the first authentication processing by using the first biological information and the identity verification information, and
the third authentication processing includes
acquiring third biological information to be generated in the terminal during or after execution of second authentication processing, and
performing the third authentication processing by using the third biological information and the master information, when second authentication processing is successful.

13. The authentication method according to claim 8, wherein
the third biological information includes biological information of a same type as that of biological information included in the first biological information.

14. The authentication method according to claim 13, wherein
the first biological information and the third biological information include a face image, and
the second biological information includes at least one of a face image, a fingerprint, a vein, and an iris.

15. The authentication method according to claim 8, wherein
each piece of processing in the first authentication processing and the third authentication processing, and processing in the second authentication processing are different from each other.

16. The non-transitory storage medium storing the program according to claim 9, wherein
the first authentication processing includes
acquiring, from a terminal, the first biological information and the identity verification information, and
performing the first authentication processing by using the first biological information and the identity verification information,
the second authentication processing is authentication processing to be performed in the terminal, and
the third authentication processing includes
acquiring third biological information from the terminal during or after execution of the second authentication processing, and
performing the third authentication processing by using third biological information, and the master information, when the second authentication processing is successful.

17. The non-transitory storage medium storing the program according to claim 9, for causing the computer further to execute:
generate the identity verification information;
generate the first biological information;
generate second biological information;
generate the third biological information; and
perform the second authentication processing by using the second biological information, wherein
the first authentication processing includes
acquiring the first biological information,
acquiring the identity verification information from the verification information generation unit, and
performing the first authentication processing by using the first biological information and the identity verification information, and
the third authentication processing includes
acquiring third biological information to be generated in the terminal during or after execution of second authentication processing, and
performing the third authentication processing by using the third biological information and the master information, when second authentication processing is successful.

18. The non-transitory storage medium storing the program according to claim 9, wherein
the third biological information includes biological information of a same type as that of biological information included in the first biological information.

19. The non-transitory storage medium storing the program according to claim 18, wherein
the first biological information and the third biological information include a face image, and
the second biological information includes at least one of a face image, a fingerprint, a vein, and an iris.

20. The non-transitory storage medium storing the program according to claim 9, wherein
each piece of processing in the first authentication processing and the third authentication processing, and processing in the second authentication processing are different from each other.
